(19) United States
(12) Patent Application Publication
(10) Pub. No.: US 2015/0235277 A1
(43) Pub. Date: Aug. 20, 2015

(54) Provision of Advertising in Social Media Content In a User Compensation Based Model

(71) Applicant: Kyle W. Bagley, Palm Beach Gardens, FL (US)

(72) Inventor: Kyle W. Bagley, Palm Beach Gardens, FL (US)

(21) Appl. No.: 14/184,209

(22) Filed: Feb. 19, 2014

(51) Int. Cl. G06Q 30/02; G06Q 50/00

(52) U.S. Cl. CPC G06Q 30/0275; G06Q 50/01

(57) ABSTRACT

System and method for providing auction-based advertising with content, such as pictures or video, transmitted via social media. A user takes a picture with a camera of his mobile communication device. The device then receives a plurality of bids from companies to incorporate advertising into the picture. A first bid is then selected from among the plurality of bids, wherein the first bid is selected either by the user or automatically based on some pre-determined criteria. Alternatively, an advertisement is selected based on a prior user agreement with the advertiser. The selected advertisement is then incorporated into the picture to produce a modified picture. The modified picture is then electronically transmitted to a plurality of followers of the user.

### FIELD OF THE INVENTION

The present invention relates to the field of social media, and more particularly, to a method for inserting advertising in images and other content provided through social media and which provides for user compensation.

### DESCRIPTION OF THE RELATED ART

Social media has become widely prevalent in modern society. One aspect of social media relates to applications which enable a user to transmit content such as images (e.g., digital photographs) to his friends and acquaintances. Examples of these social media applications include Instagram, Instagram Direct, and Snapchat, among others. These social media applications are attempting to incorporate advertising into user communications in order to produce revenues from their applications. However, improved systems and methods are desired for providing advertising with social media content.

### SUMMARY

Various embodiments are presented of a system and method for providing advertising with social media content, and in particular providing advertising with images or videos, provided through social media. The methods herein may be used with any of various social media content, such as pictures taken with a smart phone camera, videos taken with a smart phone camera, posts made on social media such as Facebook, etc. Embodiments are described below primarily with respect to pictures for convenience.

For example, the user of a mobile device may take a picture, or record a video, with his mobile device camera and decide to upload this picture through a social media application. The social media application may be, comprise, or be associated with the Plixity™ system.

Advertisers may then bid on the opportunity to provide advertising in conjunction with the user submitted photos, images, etc. based on various criteria. This criteria may include, but is not limited to, the number of followers of the submitting user, demographics of the user and/or followers, profile information of the user and/or followers, user habits or purchasing history, and geographic information, among others. A server may operate to provide all necessary information to advertisers for them to define their bid. Advertisers can thus submit their bid information based on any of the above criteria or other characteristics. For example, the advertiser's bid information may also be based on the geographic location of the user's mobile device.

These bids may then be shown to the user during the process for user to select the desired bid/advertiser. The system may also allow for non-bidding engagement, which provides for automatic selection of a bid without the user having to manually choose a bid, i.e., this does not give the user the ability to choose from submitted bids. In this embodiment, a bid may be automatically selected in software, e.g., the highest bid.

Once an advertiser is selected, the user may then select the advertiser's image/advertisement of their choice based on the submitted options. For example, the user may be able to select the banner style, location, font or other characteristics of the advertisement. Alternatively, the method may automatically select the form and/or content of the advertisement based on criteria previously selected by the user.

In another embodiment, advertisers may previously have submitted offers to a user for incorporation of their advertisements into the user's social media content. These offers may be based on any of the various criteria mentioned above, including number of followers, wealth or demographic information of the user or followers, prominence of the user, etc. If the user selects an advertiser's offer, then advertisements of the advertiser are then automatically inserted into the user's social media content (pictures or movies) for transmission to the user's followers. Alternatively, the user may be able to select the specific ad of the advertiser to incorporate into the picture.

In another embodiment, an advertiser may have previously entered into an arrangement with the user for incorporation of the advertiser's advertisements into social media content of the user. This arrangement may have been a standard offer made by the advertiser and accepted by the user. For example, the advertiser may put out an offer to certain users to compensate them for including its advertising in the user's social media content, where the compensation is based on one or more of the criteria mentioned above. Alternatively, the previously entered into arrangement may have been a negotiated agreement between the user and the advertiser.

The advertisement is incorporated into the image in some manner, either by software executing on the mobile device or by a separate server. The mobile device (or server) then communicates the image (the picture that was taken) including the advertisement to the user's followers.

The user who has agreed to placement of the advertisement in the image may receive some form of compensation based on the bid made by the advertiser. For example the user may be paid/rewarded with credit card gift cards or general gift cards from user or system selected vendors. The compensation may only accrue after certain milestones are reached, such as a threshold number of followers having received ad-incorporated pictures.

Embodiments of the invention may be implement in an online process (implemented by a server) or an embedded process (implemented within the mobile device transmitting the social media content), or some combination thereof. In some embodiments, the software which implements the methods described herein (referred to as the Plixity™ software) may be incorporated into existing social media applications, such as Instagram™, Snapchat™, or others. Thus in these implementations the user is able to operate entirely within a social media application and implement the methods described herein.

Where the methods described herein are embedded or integrated in a current social media software application, the social media software application may then receive a percentage of bid amounts from each user. For example, if Instagram™ incorporates the Plixity software described herein, Instagram™ may receive a percentage of all user's compensation when Instagram™ allows an advertisement to be included with an uploaded photo.

### BRIEF DESCRIPTION OF THE DRAWINGS

A better understanding of the present invention can be obtained when the following detailed description of the preferred embodiment is considered in conjunction with the following drawings, in which:

FIG. 1 illustrates an example social media network system according to one embodiment;

FIG. 2 is a flowchart diagram illustrating a bidding based method for providing advertising in social media content according to one embodiment;

FIG. 3 is a flowchart diagram illustrating an automatic bidding based method for providing advertising in social media content according to another embodiment;

FIG. 4 is a flowchart diagram illustrating an automatic method for providing advertising in social media content according to another embodiment;

FIG. 5 is a screenshot of a mobile device which displays advertising bids; and

FIGS. 6 and 7 illustrate example design flows of the method described herein.

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims.

### DETAILED DESCRIPTION OF THE INVENTION

### Terms

The following is a glossary of terms used in the present application:

Mobile Device (or Mobile Communication Device)—any of various types of computer systems or devices which are mobile and perform wireless communications. Examples of mobile devices (also referred to as UE devices) include mobile telephones or smart phones (e.g., iPhone™, Android™-based phones, etc.), portable gaming devices (e.g., Nintendo DS™, PlayStation Portable™, Gameboy Advance™, iPhone™), laptops, PDAs, portable Internet devices, music players, data storage devices, or other handheld devices, etc. In general, the term “mobile device” can be broadly defined to encompass any electronic, computing, and/or telecommunications device (or combination of devices) which is mobile and capable of wireless communication. Mobile devices may commonly be mobile or portable and easily transported by a user, though in some cases substantially stationary devices may also be configured to perform wireless communication.

Memory Medium—Any of various types of memory devices or storage devices. The term “memory medium” is intended to include an installation medium, e.g., a CD-ROM, floppy disks 104, or tape device; a computer system memory or random access memory such as DRAM, DDR RAM, SRAM, EDO RAM, Rambus RAM, etc.; a non-volatile memory such as a flash, magnetic media, e.g., a hard drive, or optical storage; registers, or other similar types of memory elements, etc. The memory medium may comprise other types of memory as well or combinations thereof. In addition, the memory medium may be located in a first computer in which the programs are executed, or may be located in a second different computer which connects to the first computer over a network, such as the Internet. In the latter instance, the second computer may provide program instructions to the first computer for execution. The term “memory medium” may include two or more memory mediums which may reside in different locations, e.g., in different computers that are connected over a network.

Carrier Medium—a memory medium as described above, as well as a physical transmission medium, such as a bus, network, and/or other physical transmission medium that conveys signals such as electrical, electromagnetic, or digital signals.

Software Program—the term “software program” is intended to have the full breadth of its ordinary meaning, and includes any type of program instructions, code, script and/or data, or combinations thereof, that may be stored in a memory medium and executed by a processor. Exemplary software programs include programs written in text-based programming languages, such as C, C++, PASCAL, FORTRAN, COBOL, JAVA, assembly language, etc.; graphical programs (programs written in graphical programming languages); assembly language programs; programs that have been compiled to machine language; scripts; and other types of executable software. A software program may comprise two or more software programs that interoperate in some manner. Note that various embodiments described herein may be implemented by a computer or software program. A software program may be stored as program instructions on a memory medium.

Graphical User Interface—this term is intended to have the full breadth of its ordinary meaning. The term “Graphical User Interface” is often abbreviated to “GUI”. A GUI may comprise only one or more input GUI elements, only one or more output GUI elements, or both input and output GUI elements.

Computer System—any of various types of computing or processing systems, including a personal computer system (PC), mainframe computer system, workstation, network appliance, Internet appliance, personal digital assistant (PDA), mobile communication device (such as a smartphone), television system, grid computing system, or other device or combinations of devices. In general, the term “computer system” can be broadly defined to encompass any device (or combination of devices) having at least one processor that executes instructions from a memory medium.

Automatically—refers to an action or operation performed by a computer system (e.g., software executed by the computer system) or device (e.g., circuitry, programmable hardware elements, ASICs, etc.), without user input directly specifying or performing the action or operation other than through the program itself. Thus the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. They are instead dictated by the program controlling the system's operation. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are automatically completed). The present specification provides various examples of operations being automatically performed in response to actions the user has taken.

The embodiments of the invention described herein may be used with any of various social media content, such as pictures taken with a smart phone camera, videos taken with a smart phone camera, posts made on social media such as Facebook™, emails, text messages, etc. Embodiments are described below primarily with respect to pictures for the sake of convenience.

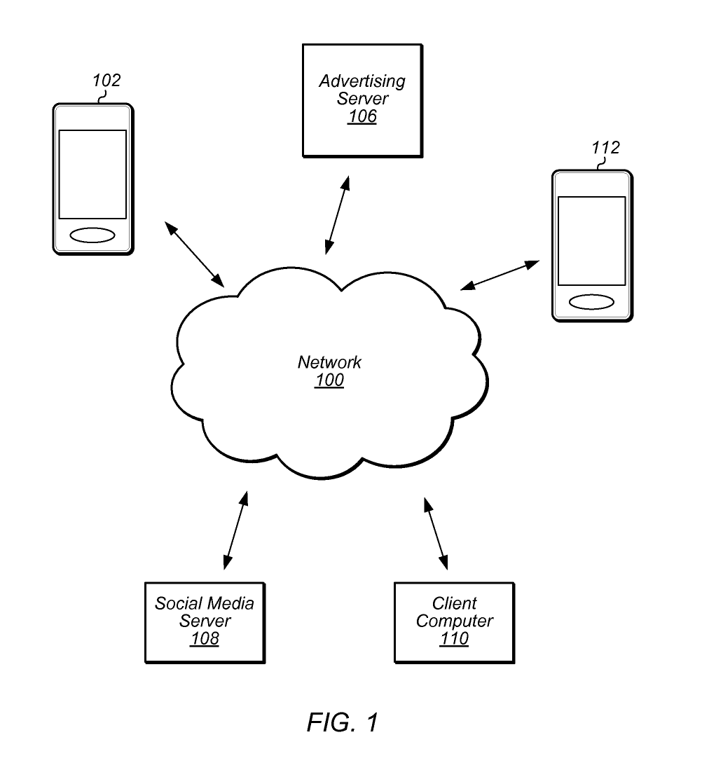

### FIG. 1—Social Media Network System

FIG. 1 illustrates a network system 100 configured to execute various of the methods described herein. As shown in FIG. 1, the system 100 may include a mobile communication device 102 wirelessly coupled to network 100, such as the Internet. The mobile communication device 102 may comprise a camera for taking pictures. Examples of the mobile communication device 102 (defined above) include any of various types of smart phones, such as the Apple iPhone™, Android™ phones, and other types of smart phones. The user of the mobile communication device 102 may desire to transmit these pictures over the network 100 to communication device(s) 112 of one or more other users (followers). In FIG. 1 device 112 is representative of one or more communication devices (which may be mobile or stationary) which receive images or pictures transmitted by device 102. Thus device 112 is representative of any of various devices configured to receive and display images, such as computer systems, mobile communication devices, etc. The users of the one or more devices 112 may be “followers” in a social media sense of the user of mobile device 102.

Mobile device 102 may comprise various components that are standard with smart phone type devices, such as at least one processor, at least one memory, a display (such as a touchscreen), an antenna, camera, etc. Also, device 112, which may be a mobile communication device of a computer system, may comprise any of various standard components, such as processor, memory medium, display, I/O devices, etc.

Advertising server 106, also referred to as the Plixity server 106, is also coupled to the network 100. The advertising server 106 may execute software, referred to as the Plixity software, which inserts advertising into images (or communications containing images) that are transmitted by mobile communication device 102 to device 112. As discussed further below, the Plixity server 106 preferably operates to insert advertisements into images with the consent of the transmitting user. Further, the Plixity server 106 may operate to enable user selection of the advertisements to be inserted, and may be based on an auction based model. Alternatively, the Plixity server 106 may facilitate the generation of offers from advertisers to users for the subsequent automatic incorporation of advertisements into the respective user's social media content.

A social media server 108 may also be coupled to the network 100. The social media server 108 may host any of various social media applications, such as Instagram™, Instagram Direc™, Snapchat™, Facebook™, etc. In one embodiment, the advertising server 106 and the social media server 108 may be implemented on a single server. For example, the Plixity™ software and one or more social media applications may both execute on a common server. As another example, the Plixity™ software may be integrated into one or more of the social media software applications executing on the social media server 108. For example, the Plixity™ software may be integrated into Instagram™, Snapchat™, etc. In an alternate embodiment, a portion or all of the Plixity software may be incorporated into the mobile communication device 102.

A client computer 110 may also be coupled to the network 100. The client computer is representative of a computer used by an advertiser to register with the advertising server 106. This may comprise the advertiser accessing the advertising server 106, e.g., through a browser-based interface, and registering bids, offers, and/or advertisements with the advertising server 106 for insertion into image communications generated by mobile devices, such as device 102. The client computer 110 may thus be used by an advertiser to register bids or offers of compensation to users, as well as for uploading one or more advertisements to the advertising server 106.

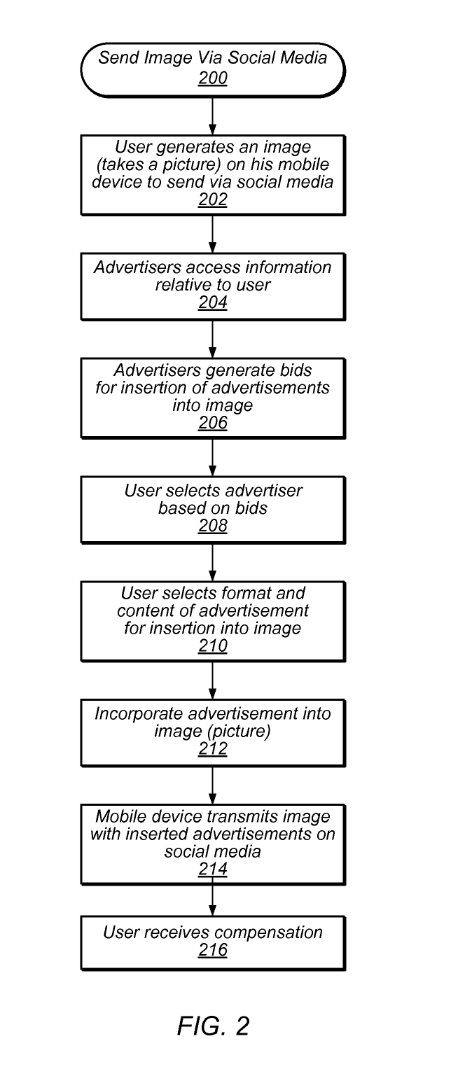

FIG. 2—Auction Based Method for Inserting Advertisements into Social Media Content

FIG. 2 illustrates a method for providing social media content with advertising incorporated into the content. As noted above, the method may be used with any of various types of social media content, such as pictures (images), videos, emails, text, posts on social media, etc. In this example embodiment, the method is described in the context of sending images (e.g., one or more pictures taken with a camera of a mobile device) to one or more other parties, wherein advertising is inserted within the image that is transmitted.

For example, at 202 the user of a mobile device may take a picture with his mobile device camera and decide to share this picture on social media. In one embodiment, the user takes the picture and selects an option to upload this picture to the Plixity server 106. It is noted that selection of a Plixity application may occur before or after the picture is taken, e.g., the picture may be taken in the Plixity software application running on the mobile device 102. In another embodiment, the user selects a social media application for transmission of the picture. Here again, selection of the social media application may occur before or after the picture is taken, e.g., the picture may be taken in the social media application software application running on the mobile device 102.

In one embodiment, the user may have previously logged into a third party social media system and selected an option giving permission to Plixity (the software executing on Plixity server 106) to read certain public information within any third party social media systems. This logging in process may in some embodiments be required to use this system. In these embodiments, when a user is signed into one or more social media systems within the Plixity system or mobile application, the user is then able to submit an image to the Plixity system. In other embodiments, no logging in or sign in process is required. In one embodiment, the user need only to download and install a Plixity app on his mobile device 102, and provide certain configuration information, in order to use the method described herein.

The user may have access to define certain rights and permissions allowing or blocking advertising companies from offering their advertisements. This allowing or blocking may be automatic or manual. For example, a user may choose not to allow any company offering or advertisement related to adult entertainment, alcohol or tobacco within the Plixity user interface mobile application or website.

In 204 advertisers may optionally access information relative to the user and in 206 generate bids for the opportunity to insert advertisements within the image. Thus advertisers can bid on the opportunity to provide advertising in conjunction with the user submitted photos, images, etc. based on various criteria. This criteria may include, but is not limited to, one or more of: the number of followers of the submitting user, demographics of the user and/or followers, profile information of the user and/or followers, user habits, geographic location of the user, geographic location of some or all of the followers, time of year, and content of the picture being transmitted, among other information. Server 106 may operate to provide all necessary information to advertisers for them to define their bid. Advertisers can thus submit their bid information based on any of the above criteria or other characteristics. For example, if a user has a large number of followers and/or followers with a relatively high income/wealth level, that user will generally receive larger bids than a user with a lesser number of followers and/or followers with a lower income/wealth level.

In some embodiments, the content of the picture itself may be used in determining the bid being made. For example, the user may take a picture which includes an item, e.g., a can of Coke™, and this may result in a larger bid from the Coca Cola Company for an advertisement inserted with that picture. In one embodiment, the user may select a company/advertiser based on content in the image he has taken to ensure that this company bids on advertising for this picture, as this picture contains a product of the company. Alternatively, the user may have a pre-arranged agreement with certain companies whereby that company's ad is automatically inserted into a picture that contains the company's product visually depicted in the picture. The user may indicate that the product appears in the picture is sold by the respective company. Alternatively, image recognition software, executing either on the user's mobile device 102 or server 106, may automatically detect the product within the image and then insert the appropriate advertisement, which typically will be associated with that product.

As noted above, the advertiser's bid information may be based on the geographic location of the user's mobile device, and may also be based on the time of year, or time of day. Thus the advertisements may be tailored to the particular geographic location in which the user and/or followers are located. As one example, the advertisements provided to users (including followers) may depend on the particular state where the user/followers reside. Alternatively, or in addition, the advertisements provided to users/followers during the summer time may be different than those provided to users during the Christmas season.

At 208 these bids may then be shown to the user during the process for user to select the desired bid/advertiser. Thus the provision of bids to the user for selection by the user may be considered an “auction-based model.” For example, the user may be presented with various possible bids and advertisers and may select the desired bid in 208. The bids may be ranked highest to lowest based on bid amount, or based on user preferences for certain companies. Alternatively, the bids may be based on past selections of the user.

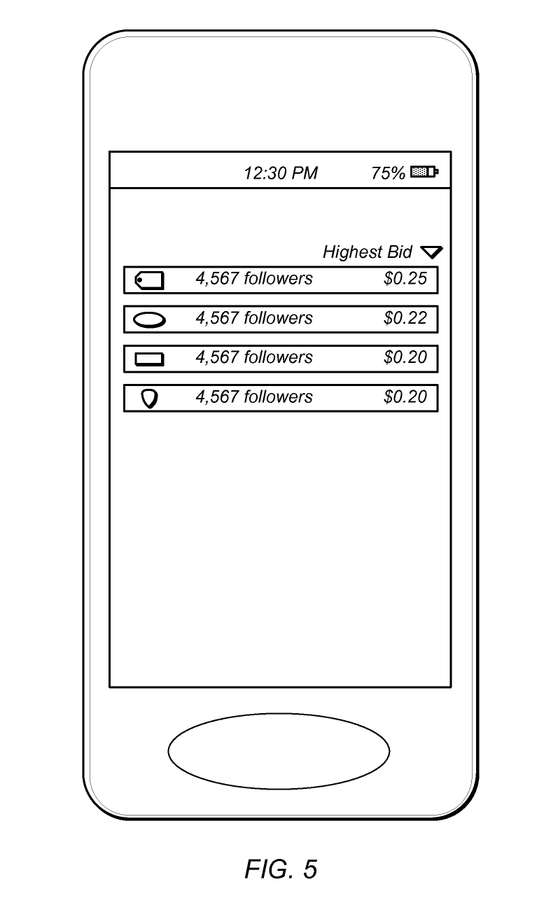

FIG. 5 is an example screen shot of mobile device 102 which shows 4 bids for advertising for a picture. As shown, the screen shot shows the names of the bidders as well as the amount bid. In this case, the highest bid is from Best Buy at 25 cents.

Once an image is taken by the user's mobile device 102 (e.g., smartphone), the application (executing on either the mobile device 102 or Plixity™ server 106) may generate the top number (e.g., 20) bids from advertisers interested in adding their logo, frame, banner, etc. onto the image. The Plixity™ software may know how many total followers the user has because the user may have previously logged into his social media account(s) from the Plixity™ application and shared this information. The number of followers is used in determining the amount that the advertiser bids for placement of the ad within the picture being transmitted.

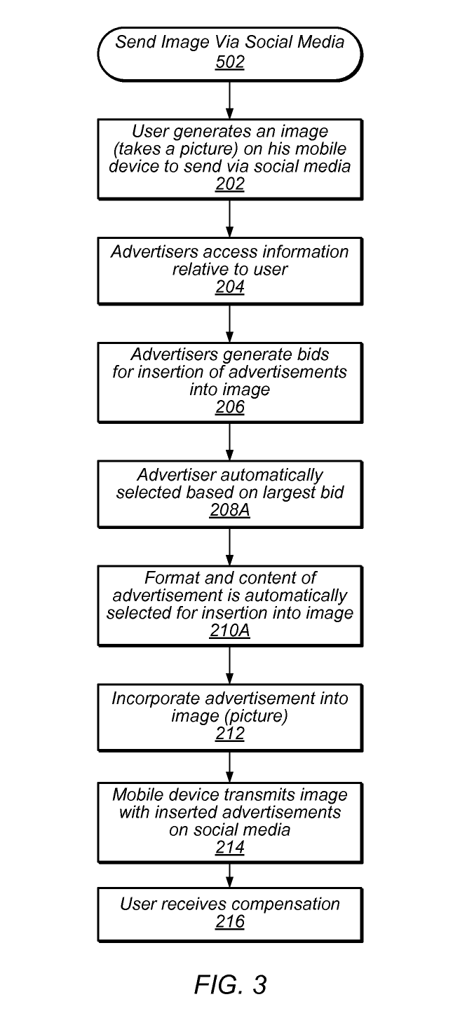

The system may alternatively perform an automatic process which does not require the user to have to choose from submitted bids (FIG. 3). In this embodiment, a bid may be automatically selected in software, e.g., the highest bid. In other words, the bid is automatically selected by software based on certain criteria, thus obviating the necessity of the user having to manually select the bid. A user may choose ahead of time to block any companies based on industry, category or specific name. For example, the user may have previously provided configuration information to prevent advertisements related to the adult industry, tobacco, alcohol, etc. The Plixity server 106 (or Plixity software executing on the mobile device 102) would in this embodiment automatically select the highest bid which is consistent with the user's preferences. Thus in this embodiment, the selection of the advertiser/bid does not require any manual user input at the time the selection is made.

Once an advertiser is selected in 208 (either automatically or manually), at 210 the user may then select the advertiser's image/advertisement of their choice based on the submitted options. For example, the user may be able to select one or more of the banner style, location, font, color or other characteristics of the advertisement. Certain of the characteristics of the advertisement may not be user configurable. For example, the size of the advertisement image may not be adjustable, or may be adjustable only to a certain degree, to prevent the user from making the advertisement image smaller than a certain size.

More specifically, once the user selects his preferred advertiser, the Plixity software may display a screen which applies the advertisement (logo or frame) to the image. The user can then swipe through all of the advertiser's logo and frame options. The advertiser may provide the user with multiple options of logos and frames (including colors, frame width, frame design, etc.). The Plixity software may provide the user the option to apply any filter used on the image to the frame as well. In one embodiment, the advertisers are allowed (or may be required) to submit multiple logos, banners, frames, etc. from which the user will select. This provides the user the flexibility to choose an advertisement that does not cover a face or a focal point of the image.

Alternatively, the method may automatically select the form and/or content of the advertisement based on criteria previously selected by the user. In this embodiment, the advertisement may have a preconfigured form and content that is not changeable by the user, and hence the user is not required to spend time selecting and/or adjusting the advertisement. Thus in this embodiment the Plixity software automatically selects and positions the advertisement within the image, and the software may use facial recognition or other recognition software to ensure the advertisement is placed at an appropriate point on the picture. As yet another alternative, the advertisement (e.g., logo or frame) is always placed in the same spot on the picture, regardless of the content of the picture.

In another embodiment, software executing either on the mobile device 102 or the advertising server 106 automatically adjusts the form/content of the advertisement based on certain criteria, such as user profile information, size of the image, colors present in the image, etc. This automatic adjustment of the form/content of the advertisement is performed without manual user input required to perform this function.

In one embodiment the advertisement is incorporated directly into the image in some manner. For example, the advertisement may partially or completely cover a subset of the pixels in the picture. In this instance, a portion or all of the advertisement image may be at least partially transparent, so that the respective portion of the image is at least partially visible behind the advertisement. Alternatively, the advertisement may complete reside outside of (e.g., below) the picture. The user may apply an effect to the photo with the incorporated advertisement, as desired.

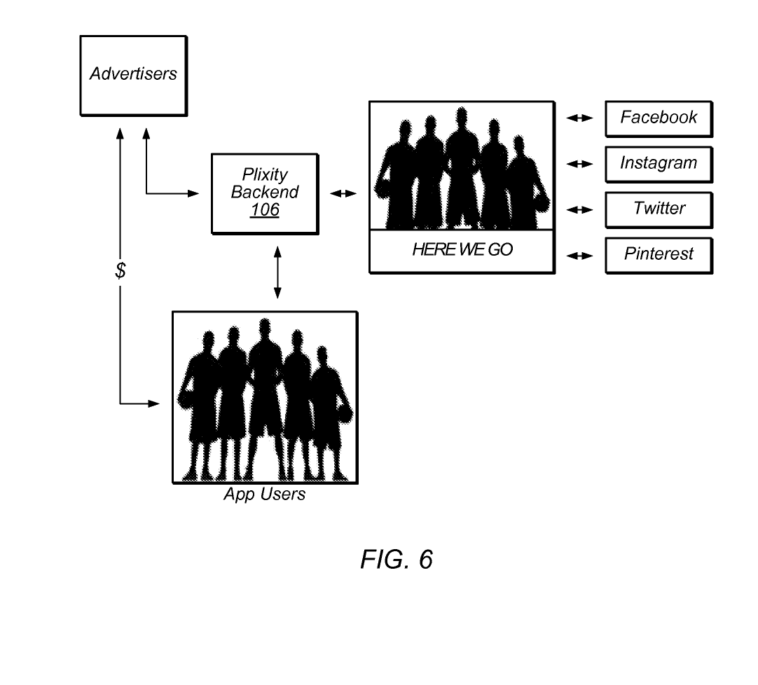

At 212 the advertisement is incorporated into the picture. Note that step 210 may be performed before, after or concurrently with step 212. In one embodiment, the incorporation of the advertisement into the picture is performed by software executing on the user's mobile device 102. Alternatively, as shown in FIG. 6, the picture taken by the user is forwarded to the Plixity server 106, and software executing on the Plixity server 106 actually performs the work of incorporating the advertisement into the picture in 212. As described above, incorporation of the advertisement into the picture may be performed manually or automatically.

At 214 the mobile device then communicates the image which now includes the advertisement to the various followers of the user. Thus the image that is transmitted includes the picture that was taken and also includes the advertisement incorporated with the picture. In one embodiment, the incorporation of the advertisement into the picture is performed by software executing on the user's mobile device 102. In this embodiment, the picture (which now incorporates the advertisement) is transmitted by the mobile device 102 to the various followers of the user. Alternatively, as shown in FIG. 6, where the Plixity™ server 106 receives the picture from the user's mobile device 102 and performs the work of incorporating the advertisement into the picture in 212, the Plixity™ server then provides the picture (which now incorporates the advertisement) to the various followers of the user. In one embodiment, social media software (such as Instagram™, Snapchat™, etc.) executing on the user's mobile device 102 incorporates the advertisement into the picture and directly sends the picture to the various followers. In yet another embodiment, social media software executing on a server incorporates the advertisement into the picture and sends the picture to the various followers.

In some embodiments, the advertisement that is included with the image is or contains a hyperlink, such that if the follower who receives the image presses on the advertisement with his touchscreen the follower is taken to a website related to the product being advertised. In another embodiment, inclusion of the advertisement with the picture may operate to convert the entire picture into a hyperlink. In this embodiment, the compensation provided to the user may be partially or completely based on whether a follower that receives the social media content with the advertisement actually selects the hyperlink to view information about the product, or possibly on whether the follower actually purchases the product being advertised through selection of the hyperlink.

At 216 the user who has agreed to placement of the advertisement in the image may receive some form of compensation based on the bid made by the advertiser. The compensation may take any of various forms. For example the user may be paid/rewarded with credit card gift cards or general gift cards from user-selected or system-selected vendors. The compensation may accrue to the user on the advertisement server 106 until the amount is sufficiently large to be incorporated into a gift card. Alternatively, the compensation may be in the form of “points” which may be similar to airline miles or other programs. As another alternative, the compensation may be in the form of credits to a website, such as Amazon.com, or to an online game.

In 216 the compensation may only be “triggered” based on accrual of a certain number of follower receipts or pictures taken, etc. For example, compensation may only accrue to the user after certain milestones have been reached, such as after X number of followers have received advertising incorporated pictures from the user.

Embodiments of the invention may be implemented in an online process (implemented by a server) or an embedded process (implemented within the mobile device transmitting the social media content), or some combination thereof. In some embodiments, the software which implements the methods described herein (referred to as the Plixity™ software) may be incorporated into existing social media applications, such as Instagram™, Snapchat™, or others. Thus in these implementations the user is able to operate entirely within a social media application and implement the methods described herein.

Where the methods described herein are embedded or integrated in a current social media software application, the social media software application may receive a percentage of bid amounts (compensation) from each user. For example, if Instagram™ incorporates the Plixity™ software described herein, Instagram™ may receive a percentage of the user's compensation when Instagram™ allows an advertisement to be included with an uploaded photo. This provides an incentive for current social media applications to enable this auction-based bidding of advertising within their applications.

FIG. 3 illustrates a method similar to that of FIG. 2, whereby the bid selection process and selection of form/content of the advertisement is automatically performed. In this embodiment, the method is essentially invisible to the user, i.e., the user is not required to manually select bids or configure the form/content of the advertisement. In this embodiment, the method shown in FIG. 3 may always be performed automatically, or this automatic method of operation may be an option selected by the user on his mobile device 102.

As shown, the steps 202-206 of the method of FIG. 3 is similar to those steps in the method shown in FIG. 2. In FIG. 3, in step 208A the method automatically selects the advertiser based on some criteria, such as the largest received bid, or the largest received bid that is consistent with the user's previously submitted criteria (e.g., which may exclude certain advertisers such as tobacco, alcohol, etc.). Thus in the method of FIG. 3 the advertiser is automatically selected, and the user of mobile device 102 is not required to view the bids and manually select a bid from among the received bids. In 210A the form and content of the advertisement is also automatically selected for insertion. Thus in the method of FIG. 3 the form and content of the advertisement is automatically selected, and the user of mobile device 102 is not required to view the advertisement and manually select or configure the form or content of the advertisement. Steps 208A and 210A may be performed by software executing on the mobile device 102 or by the advertising server 106 (or by social media server 108), or a combination thereof. Steps 212-216 of FIG. 3 may be performed as described in FIG. 2 above.

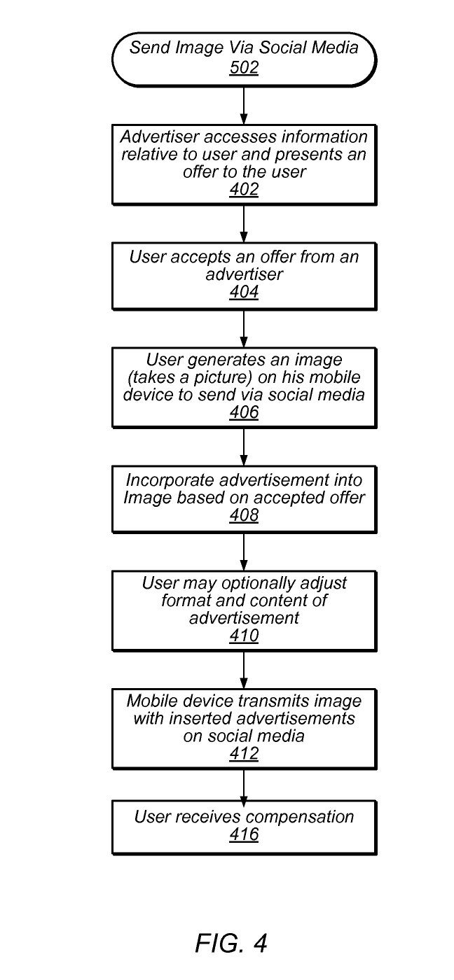

FIG. 4—Inserting Advertisements into Social Media Content (not Bid Based)

FIG. 4 illustrates a method for providing social media content with advertising. The method comprises sending images (e.g., one or more pictures taken with a camera of a mobile device) to one or more other parties, wherein advertising is inserted within the image that is transmitted. As noted above, the method may be used with any of various types of social media content, such as pictures (images), videos, emails, text, posts on social media, etc. In this example embodiment of FIG. 4, the method is described in the context of sending images (e.g., one or more pictures taken with a camera of a mobile device) to one or more other parties, wherein advertising is inserted within the image that is transmitted.

This example embodiment is not auction-based on a per picture basis. In other words, in this embodiment no bidding occurs for each picture, i.e., advertisers do not bid for the option to incorporate their advertising into each respective picture. Rather, an advertiser has previously reached an agreement with a user to incorporate ads of the advertiser into the user's social media content. In one embodiment, an auction-based process is performed at the offer stage to reach an agreement with particular users, after which the incorporation of advertisements is performed automatically as described herein.

For example, at 402 the advertiser may present an offer to the user for the incorporation of advertising into the user's transmitted social media content. Thus an advertiser may offer compensation (or the possibility of compensation) to the user if the user chooses to allow incorporation of advertising into the user's social media content that they provide to other users (followers). This offer for compensation may be provided through the Plixity Service (Plixity server 106), or may be provided through any of various methods.

The offer may be a generic or standard offer that is made to a large number of users, with compensation based on certain milestones. For example, an advertiser may offer compensation for advertisement incorporated social media transmissions, where the amount of compensation is based on criteria such as number and/or type of followers who actually received this ad-incorporated social media content. Thus the offer may include a standard schedule for an amount of compensation paid to the user for the incorporation of advertising into the user's transmitted social media content. For example, the offer may provide for compensation that is based on the number of followers of the user, the profile of the user or his/her followers, etc. For example, if the user has a “high profile”, e.g., is popular, famous, etc., the user may ultimately receive higher compensation from the standard offer that is made. For example, sports stars, movie star, television/radio personalities, etc., may receive higher ultimate compensation based on their large follower base. Thus, a user with a large number of followers may ultimately receive higher compensation than a user with a lesser number of followers.

In another embodiment, the amount of compensation offered may not be based on a generic schedule, but rather may be based on information about the particular user. For example, the offer may provide for compensation that is based on verifiable information provided by the user, such as the number of followers of the user, the profile of the user or his/her followers, etc. For example, if the user has a “high profile”, e.g., is popular, famous, etc., the user may receive a larger offer. For example, sports stars, movie star, television/radio personalities, etc., may receive higher offers based on their perceived popularity. The compensation offered to the user may also be conditional, e.g., may be conditioned upon the user submitting a certain number of pictures with incorporated advertising and/or pictures with incorporated advertising to a minimum number of followers.

In one embodiment, the Plixity server 106 may gather information from various users, or from entities that collect information about users. For example, various social media applications, or other entities, may collect information about their users, including number of followers, popularity, etc. This information may then be accessible to advertisers for use by the advertiser in formulating offers to users. An advertiser may access the Plixity server 106 to access information about various users, and then may generate offers to ther users based on this information. In another embodiment, users may register with the Plixity server and provide configuration information, which is then accessible to advertisers for use in generating offers.

The offers, which may be standard or user-specific, may be presented to users in any of various manners. For example, the user may be presented with an offer on his mobile device 102 from a particular company (advertiser) to allow incorporation of advertising into the user's social media content. As one example, the user may be presented with multiple offers from different advertisers, and the user may select the offer that he prefers, e.g., based on the amount of compensation, his agreement with or liking of the products being advertised, etc. The offers may come in the form of emails, text messages, messages on social media, etc. As another alternative, the offers may come from a dedicated application running on the user's smart phone. In this example, the user selects an application (the Plixity application) on his smartphone and can then view and select offers from advertisers. As another example, the user may view and select offers from within any of various social media applications such as Facebook™, Instagram™, SnapChat™, etc. As another alternative, the may access a website to view offers of various advertisers. This website may be presented by the Plixity server 106 or by respective individual advertisers or social media servers.

In one embodiment the offer may be an offer to embed advertisement into the user's social media content for a defined date range. In this embodiment, the offer to the user may allow one or more company advertisements to be embedded in his/her social media content, e.g., submitted photos, automatically or manually for a set range of time. For example, the offer may be to allow Coke™ to embed their advertisement to all submitted photos for the entire month of December. As noted above, this offer may be a standard or generic offer presented to a large number of users with compensation based on certain milestones of transmitted social media content which includes advertisements. Alternatively, the offer may be user-specific and based on data gathered by the Plixity servers and presented to Coke™. Coke™ values this user based on all information gathered by Plixity servers by accessing user's shared data. As part of the offer, Coke™ may agree to compensate the user if the user reaches the quota (milestone) of photo submissions Coke™ has set.

The offer may also include limits on the amount of pictures to be sent per day, or the number of followers receiving pictures per day. This may help prevent a user from flooding large numbers of pictures on the Internet to his followers merely for the sake of increased compensation.

Thus advertisers can offer the opportunity to provide advertising in conjunction with the user submitted photos, images, etc. based on various criteria. This criteria may include, but is not limited to: the number of followers of the submitting user, demographics of the user and/or followers, profile information of the user and/or followers, user habits, geographic location of the user, geographic location of some or all of the followers, time of year, content of the picture being transmitted, among other information. A server may operate to provide all necessary information to advertisers for them to define their offer. Advertisers can thus submit their offer information based on any of the above criteria or other characteristics. For example, if a user has a large number of followers with a relatively high income/wealth level, that user will generally receive larger offers than a user with a lesser number of followers and/or followers with a lower income/wealth level.

The advertiser's offer may be based on the geographic location of the user's mobile device, and may also be based on the time of year, or time of day. Thus the conditions of the offer may be tailored to the particular geographic location in which the user and/or followers are located.

In another embodiment, the advertisement incorporated into the social media content includes a hyperlink (or transforms the entire picture into a hyperlink). In this embodiment, the compensation provided to the user may be partially or completely based on whether a follower that receives the social media content with the advertisement actually selects the hyperlink to view information about the product. Alternatively, or in addition, the compensation provided to the user may be partially or completely based not only on whether a follower actually selects the advertisement hyperlink to view information about the product, but also whether the follower actually makes a purchase of the product being advertised by using the hyperlink. For example, a follower's selection of the advertisement hyperlink may launch a web site on the follower's device that enables the follower to purchase the product being advertised. In one embodiment, compensation to the user may be made, or increased, if a follower actually follows through with a purchase of the product being advertised based on selection of the hyperlink in the social media content (e.g., the advertisement in the picture).

At 404 the user may create some type of relationship with an advertiser, e.g., may accept an offer from an advertiser. In other words, the user may accept an offer that was made in 402 above, e.g., from a certain advertiser. Acceptance of the offer by a user may allow one or more company advertisements to be embedded in the social media content. The date range for the offer may be specified in the offer, or alternatively the user may be able to adjust or change (to a certain degree) the date range of the offer.

In 402 a number of offers may be presented to the user for user to select the desired offer/advertiser. For example, the user may be presented with various possible offers and advertisers and may select the desired offer at 404. The offers may be presented to the user in a ranking of highest to lowest based on offer amount, or based on user preferences for certain companies. Alternatively, the offers may be presented to the user based on past selections of the user. Thus where multiple offers are presented to the user for selection by the user, this selection of one or more offers by the user may be considered a type of “auction-based model”, although this auction-based model is different from the per picture bidding based auction model described in FIGS. 2 and 3. In one embodiment, the user may select or accept multiple offers at the same time, and thus different types of advertisements may be included in different pictures that the user uploads to his followers.

In one embodiment, when the user accepts an offer from an advertiser, the advertiser transmits one or more advertisements to the user's mobile device 102 so that they can be readily incorporated into the user's transmitted social media. Alternatively, after the user accepts an offer, the user's mobile device 102 may be provided with information regarding the location of the advertiser's advertisements on a server, such as a server hosted by the advertiser, or the Plixity server 106. In yet another embodiment, when the user accepts an offer from an advertiser, the advertiser transmits information to advertising server 106 to enable the advertiser's ads to be incorporated into the user's transmitted social media content, e.g., pictures.

At 406 the user of a mobile device may take a picture with his mobile device camera and decide to share this picture on social media. When the picture is taken, certain metadata may optionally be stored with the picture, such as the time the picture was taken, the geographic location of the mobile device 102 when the picture was taken, etc. In one embodiment, the user takes the picture within the Plixity application running on his mobile device 102, or from within a social media application that incorporates the functionality described herein.

At 408 an advertisement is incorporated into the picture based on the previously accepted offer (thereby creating a “modified picture”). The incorporation of the advertisement into the picture may be performed at the mobile device 102. For example, as described above, the advertiser may have previously transmitted advertisements to the mobile device 102 which are then stored on the mobile device. When the user has taken a picture and selects an option to upload the picture to social media, an application executing on the mobile device 102 may execute to incorporate the advertisement into the picture. Alternatively, the advertiser may have previously transmitted information to the mobile device 102 regarding where advertisements are located on a server, such as server 106 or a server hosted by the advertiser. In this embodiment, when the user has taken a picture and selects an option to upload the picture to social media, an application executing on the mobile device 102 may access the server to retrieve an advertisement from the server and incorporate the advertisement into the picture. In yet another embodiment, the mobile device 102 may have some ads stored locally and may be able to access other ads from a server coupled to the Internet. As yet another alternative, the user's mobile device 102 may transmit the picture to advertising server 106, which incorporates the appropriate advertising into the picture and then relays the modified picture to the user's followers.

The content of the advertisement may be based on any one or more of various criteria. For example, as noted above, the content of the advertisement may be based on the geographic location of the mobile device and/or the current time period. In one embodiment, the content of the advertisement may be based on the geographic location of the mobile device at the specific time of either the taking of the picture or the uploading of the picture to social media. As one example, the advertisements provided to users (including followers) may depend on the particular state where the user/followers reside. Alternatively, or in addition, the advertisements provided to users/followers during the summer time may be different than those provided to users during the Christmas season.

At 410, the user may be able to adjust the form and/or content of the advertisement, possibly within certain constraints set by the advertiser or the application executing on the user's mobile device 102. Alternatively, the user may be able to view the picture with the incorporated advertisement, but may not be able to modify it.

At 412 the picture with the incorporated advertisement is transmitted to followers of the user over the network 100, e.g., over a cellular network and/or the Internet. Where the incorporation of the advertisement into the picture is performed on the mobile device 102, the mobile device 102 may transmit the modified picture over the network 100 to the followers, possibly through one or more servers such as server 106. Where the incorporation of the advertisement into the picture is performed on a server, such as server 106, that is separate from the mobile device 102, the server 106 may transmit the modified picture over the network 100 to the followers of the user.

As described above, the advertisement (or the picture itself) may contain or itself actually be a hyperlink that references information about the product or service being advertised. The hyperlink may be selected by a recipient follower to enable him to gain more information about, or actually purchase, the product or service being advertised.

At 416 the user may be compensated in some form based on the incorporated advertisement. Compensation provided in 416 may be similar to that described in 216 above. As described above, where the advertisement (or the picture) includes a hyperlink, in one embodiment all or a portion of the compensation that the user receives may be based on the number of followers who either: 1) select the hyperlink of the advertisement to view information about the product being advertised; and/or 2) select the hyperlink of the advertisement to actually purchase the product being advertised. In one embodiment, all of the compensation provided to the user is based totally on the occurrence of either 1 and/or 2 above. In another embodiment, the user receives increased compensation when 1 and/or 2 are performed by followers.

FIG. 6 illustrates an example system flow diagram of the system described herein. FIG. 6 is merely one example, and various types of operational scenarios are possible. As shown, advertisers (companies) create accounts and may submit their advertisements, e.g., “frame designs”, that will be applied to app submitted photos from users. They can upload as many “frames” as they desire to be applied to photos. Advertisers may also select how much they are willing to pay app users for their advertisements, e.g., frames.

The advertisements (frames) may be submitted to the Plixity Backend, which may be implemented by server 106. The Plixity Backend may operate to store the advertiser's information (advertisements and configuration information). The Plixity Backend may also allow app users to log into their social media accounts to view friends, post on walls, view likes, etc.

The app user (user of mobile device 102) may take a picture and submit it to the Plixity Backend as shown. The Plixity Backend may then add the appropriate advertisement (frame) to the picture that was taken. In the example shown in FIG. 5, the advertisement that is inserted into the picture is the phrase “Here We Go” accompanied with a company's logo or trademark (not shown) and/or images of the company's products (not shown). Thus the phrase “Here We Go” in FIG. 5 is representative of advertising that would indicate a specific company's trademarks or products, although actual trademarks are not shown in the “Here We Go” advertisement of FIG. 5.

The advertisement added to the frame may be selected at least partially based on the likes, friends, etc. of the app user and/or followers of the user, among other information as discussed above. Once the advertisement has been added to the taken picture, the resulting picture may then be provided through the network to any of various social media applications, such as Facebook, Instagram, Snapchat, Twitter, and Pinterest, among others.

The Plixity Backend may also allow advertisers to pay (credit) app users for adding a frame to their photo, represented in FIG. 5 by the dollar sign arrow from the advertisers to the app users.

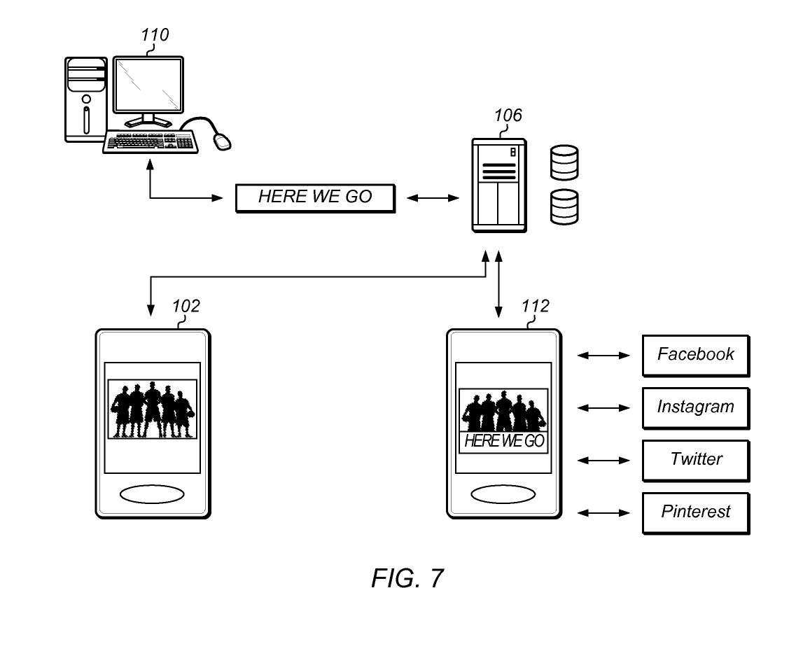

FIG. 7 illustrates an example process flow diagram of the method described herein. As noted above, companies may utilize a client computer, such as computer 110 to access the Plixity server 106 to register for providing bids and advertising as described herein. The Plixity system may be open to all reputable companies wishing to advertise on social media. The system may have an automatic sign up process directly from the website for companies that wish to advertise.

Once companies have created an online account with the Plixity system 106, they may have access to define their criteria (parameters or demographics of potential users) for advertising. This may include, but is not limited to past, present or future: metadata, location, gender, interests, any social media data describing the user, age, relationship status, sexual orientation, job, occupation, children, languages, education, work place, frequency of use on any social media software, etc. Advertising companies may not have direct or indirect access to user's third party social media accounts. The company will then create, outside of the system and if not already and in no particular order, advertisements that may include, but not limited to: logos, banners, icons, images, slogans, frames, etc, which may be black and white or in color, to upload to the system 106. Companies may be able to suggest or assign certain advertisements to certain sets of demographic information of any user. For example, the company may configure system to only suggest certain advertisements, or provide only certain advertisement offers, to users 21 years of age and older. Companies may add any number of individual demographic data to suggest their advertisement. Companies can edit any parameters anytime by accessing their online account on the Plixity system.

As shown in FIG. 6, the company may upload desired advertisements to the advertisement server 106. In the example shown in FIG. 6, the company may upload an advertisement containing the words “Here We Go” to the server 106. As noted above in FIG. 6, the phrase “Here We Go” in FIG. 7 is accompanied by a company's logo or trademark (not shown) and/or images of the company's products (not shown). Thus the phrase “Here We Go” in FIGS. 6 and 7 is representative of advertising that would indicate a specific company's trademarks or products, although actual trademarks are not shown in FIGS. 6 and 7.

Users may create online/mobile application accounts with the Plixity server 106. Creation of the online account may comprise the user providing configuration information to the advertisement server which indicated desired (or prohibited) advertising. These accounts may enable the bidding based method described in FIG. 2 or 3, or the offer-based method described in FIG. 4. In another embodiment, user registration to the server 106 may not be required. Rather, these steps may instead by performed by an application installed on the user's smart phone 102.

After the user takes a picture (digital photo) and submits the photo to server 106 over the network, the system 106 may identify any or all companies that have defined parameters of users to whom they wish to offer an advertisement. The process of delivering bids for advertisements, selection of a bid (or advertisement) and incorporation of the advertisement into the picture, may then performed as described above in FIGS. 2 and/or 3. For example, if any of the user's information matches with any company's single or set of predefined parameters, the offer from the company may show automatically or manually be presented on the user's mobile device 102 for selection by the user. Alternatively, incorporation of the advertisement into the picture may be automatically performed based on a previously accepted offer as described in FIG. 4.

Alternatively, the server 106 may automatically select and insert an appropriate advertisement into the uploaded picture based on the user's configuration information. The server 106 may then forward the now modified picture on to the followers (represented by device 112) of the user without further involvement of the user of the mobile device 102. In this embodiment, the user is not required to manually select from bids or even preview the advertisement. Note that the user preferably receives some form of compensation for the incorporation of the advertisement into his picture and the transmission of the modified picture (the picture including the advertisement) to his/her followers, and/or from his follower's interaction with the advertisement hyperlink.

In yet another embodiment, the mobile device 102 of the user has previously received one or more acceptable advertisements from users, and the incorporation of the advertisement into the picture taken by the camera of the mobile device 102 is performed by software executing on the mobile device 102.

The methods describe herein provide a framework whereby users of social media can participate in, and profit from, incorporation of advertising into their electronic transmissions to followers. For celebrities that have a large number of followers, this may provide a form of advertising related compensation to these celebrities that is not dependent upon any pre-negotiated endorsement contracts. Alternatively, as described in the method of FIG. 4, certain celebrities may desire to negotiate with advertisers to enable automatic (or manual) insertion of advertising into their electronic transmissions (e.g., picture transmissions) using the methods described herein.

Although the embodiments above have been described in considerable detail, numerous variations and modifications will become apparent to those skilled in the art once the above disclosure is fully appreciated. It is intended that the following claims be interpreted to embrace all such variations and modifications.

We claim:

1. A non-transitory computer accessible memory medium that stores program instructions executable by a processor to implement:
storing a picture in a memory, wherein the picture was taken by a camera of a mobile communication device, wherein the mobile communication device is operated by a user;
receiving a plurality of bids to incorporate advertising into the picture;
selecting a bid from among the plurality of bids;
incorporating an advertisement into the picture to produce a modified picture, wherein the advertisement corresponds to the bid;
electronically transmitting the modified picture to a plurality of followers of the user.

2. The non-transitory computer accessible memory medium of claim 1,
wherein the program instructions are further executable to provide compensation to the user for incorporating the advertisement into the picture and electronically transmitting the modified picture to the plurality of followers of the user.

3. The non-transitory computer accessible memory medium of claim 1,
wherein at least a subset of the plurality of bids includes compensation to the user for incorporating the advertisement into the picture.

4. The non-transitory computer accessible memory medium of claim 1,
wherein an amount of at least a subset of the bids is at least partially based on a number of followers of the user.

5. The non-transitory computer accessible memory medium of claim 1,
wherein said selecting the first bid is performed by the user.

6. The non-transitory computer accessible memory medium of claim 1,
wherein said selecting the first bid comprises:
displaying at least a subset of the plurality of bids on a display of the mobile communication device; and
receiving input from the user selecting the first bid, wherein the input from the user is provided to select the first bid presented on the display of the mobile communication device.

7. The non-transitory computer accessible memory medium of claim 1,
wherein said selecting the first bid is performed automatically by software.

8. The non-transitory computer accessible memory medium of claim 1,
wherein said incorporating the advertisement into the picture comprises receiving user input modifying a characteristic of the advertisement being incorporated into the image.

9. The non-transitory computer accessible memory medium of claim 1,
wherein the plurality of bids are received over a network.

10. A method for providing pictures containing advertising in social media, the method comprising:
storing a picture in a memory, wherein the picture was taken by a camera of a mobile communication device, wherein the mobile communication device is operated by a user;
receiving a plurality of bids to incorporate advertising into the picture;
selecting a first bid from among the plurality of bids;
incorporating an advertisement into the picture to produce a modified picture, wherein the advertisement corresponds to the first bid;
electronically transmitting, over a network, the modified picture to a plurality of followers of the user.

11. A non-transitory computer accessible memory medium that stores program instructions executable by a processor to implement:
storing a picture in a memory, wherein the picture was taken by a camera of a mobile communication device, wherein the mobile communication device is operated by a user;
incorporating an advertisement into the picture to produce a modified picture, wherein the advertisement is at least partially based on configuration information previously provided by the user;
electronically transmitting, over a network, the modified picture to a plurality of followers of the user.

12. The non-transitory computer accessible memory medium of claim 11,
wherein the program instructions are further executable to receive compensation to the user for incorporating the advertisement into the picture and electronically transmitting the modified picture to the plurality of followers of the user.

13. The non-transitory computer accessible memory medium of claim 11,
wherein the compensation is at least partially based on a number of followers of the user.

14. The non-transitory computer accessible memory medium of claim 11,
wherein the configuration information comprises information specifying certain types of advertising that are prohibited from incorporation into the picture.

15. The non-transitory computer accessible memory medium of claim 11, wherein the program instructions are further executable to:
receive, by the mobile device, at least one offer from an advertiser to incorporate advertisements into social media content transmitted by the mobile device.

16. The non-transitory computer accessible memory medium of claim 10, wherein the at least one offer is based on profile information of the user.

17. A non-transitory computer accessible memory medium that stores program instructions executable by a processor to implement:
storing social media content in a memory, wherein the social media content was generated by a mobile communication device, wherein the mobile communication device is operated by a user;
incorporating an advertisement into the social media content to produce modified social media content, wherein the advertisement is at least partially based on configuration information previously provided by the user;
electronically transmitting, over a network, the modified social media content to a plurality of followers of the user;
wherein compensation is received by the user for incorporating the advertisement into the social media content and electronically transmitting the modified social media content to the plurality of followers of the user

18. A mobile communication device operated by a user, comprising:
a camera for taking pictures;
a processor;
memory coupled to the processor, wherein the memory stores storing a picture, wherein the picture was taken by the camera;
wherein the memory stores program instructions for incorporating an advertisement into the picture to produce a modified picture, wherein the advertisement is at least partially based on configuration information specified by the user;
an antenna for performing wireless communications with a network, wherein the antenna is configured to electronically transmit, over the network, the modified picture to a plurality of followers of the user.

19. The mobile communication device of claim 18,
wherein compensation is received by the user for incorporating the advertisement into the picture and electronically transmitting the modified picture to the plurality of followers of the user.

20. A mobile communication device operated by a user, comprising:
a camera for taking pictures;
a processor;
memory coupled to the processor, wherein the memory stores storing a video, wherein the video was taken by the camera;
wherein the memory stores program instructions for incorporating an advertisement into the video to produce a modified video, wherein the advertisement is at least partially based on configuration information specified by the user;
an antenna for performing wireless communications with a network, wherein the antenna is configured to electronically transmit, over the network, the modified video to a plurality of followers of the user.

21. The mobile communication device of claim 20,
wherein compensation is received by the user for incorporating the advertisement into the video and electronically transmitting the modified video to the plurality of followers of the user.
